(19) United States
(12) Patent Application Publication
(10) Pub. No.: US 2026/0104631 A1
(43) Pub. Date: Apr. 16, 2026

(54) MOUNTING SYSTEM FOR A CAMERA

(71) Applicant: Staibano&Grbac Patents eGbR, Friedrichshafen (DE)

(72) Inventors: Jan-Luca STAIBANO, Bodelshausen (DE); Adrian Mateo GRBAC, Friedrichshafen (DE)

(73) Assignee: Staibano&Grbac Patents eGbR, Friedrichshafen (DE)

(21) Appl. No.: 19/342,810

(22) Filed: Sep. 29, 2025

(30) Foreign Application Priority Data
Oct. 14, 2024 (DE) 10 2024 129 761.1

(51) Int. Cl. G03B 17/56; F16M 11/12

(52) U.S. Cl. CPC G03B 17/561; F16M 11/12

(57) ABSTRACT

A cost-effective mounting system for a camera for position stabilization and for damping vibrations has damping and decoupling behavior that is individually adjustable and can be quickly adapted to different scenarios. The mounting system includes a holding arm with two end pieces and two cross members that are articulated to the end pieces to form a parallelogram. Each cross member is associated with anchor points for attaching at least one elastic band. The holding arm has at least two anchor points at which guide rollers are arranged, to which at least one elastic band is attached, The guide rollers are rotatably attached on fastening bolts on the holding arm and adjustable braking elements are associated with the fastening bolts.

### CROSS REFERENCE TO RELATED APPLICATIONS

Applicant claims priority under 35 U.S.C. §119 of German Application No. 102024 129 761.1 filed October 14, 2024, the disclosure of which is incorporated by reference.

### BACKGROUND OF THE INVENTION

### FIELD OF THE INVENTION

The present invention relates to a mounting system for a camera for position stabilization and for damping vibrations, comprising a holding arm with two end pieces and two cross members, wherein the cross members are articulated to the end pieces to form a parallelogram and each cross member is associated with a plurality of anchor points for attaching at least one elastic band.

### DESCRIPTION OF THE RELATED ART

Such a mounting system is disclosed in DE 2729154 A1. It is connected to the belt area of a carrier and works with springs that are designed to compensate for any movement of the carrier in order to stabilize a camera received on the mounting system.

General mounting systems are already known from US 10,393,476 B2. Here, a system is described that can be attached on a vest and minimizes the perceived weight of an object attached to the system for a carrier. This is done via a mountable parallelogram, on which anchor points are provided for fastening elastic bands or springs. While the object held thereby always remains firmly in the hands of the carrier, such a mounting system can also be useful for minimizing impact, however, a complete decoupling of the attached object from the carrier or the complete decoupling or damping of any vibrations that may occur is not intended here.

A common problem, in particular when using cameras, is that the movement of the carrier and its slight changes in position are transmitted to the camera as vibrations, blurring the recorded image unless their transmission is minimized as much as possible. In the ideal case of vibration-damped mounting systems, the object to be held follows horizontal movements due to initially given inertia in this direction, while its vertical movement remains completely unaffected by that of the carrier. The carrier can keep the object suspended hands-free next to his body on the other end of the arm without the vertical position of the object changing, even during impulsive vertical movements of the carrier, which can be caused by sprinting, among other things. There are still possibilities for fully automated electronic damping of vibrations. For example, EP 3873705 B1 discloses a high-end mounting system for a camera which, with additional sensors and feedback-controlled electronics and several rotational degrees of freedom, achieves image stabilization by damping vibrations of the installed control electronics. Even the smallest position changes are automatically registered and corrected. However, such systems are often maintenance-intensive and difficult to adjust to change their handling. In addition, such systems are expensive to purchase and their usage time is substantially limited to the battery life. Furthermore, such systems are heavy and therefore unwieldy due to their complexity, and their load-bearing capacity is limited by their electronics.

### SUMMARY OF THE INVENTION

Against this background, the object of the present invention is to create a cost-effective mounting system that enables adjustable decoupling of an object from the carrier as well as adjustable damping behavior of occurring vibrations.

This is achieved by a mounting system in accordance with the features of the invention. Meaningful configurations of such a device can be found below.

In this respect, a mounting system for a camera for position stabilization and for damping vibrations is provided, comprising a holding arm with two end pieces and two cross members, wherein the cross members are articulated to the end pieces to form a parallelogram and each cross member is associated with a plurality of anchor points for attaching at least one elastic band. According to the invention, the mounting system is characterized in that at at least two anchor points of the holding arm guide rollers are arranged, to which at least one elastic band is attached, wherein the guide rollers are rotatably mounted on fastening bolts on the holding arm and adjustable braking elements are associated with the fastening bolts.

The present invention, through its design, enables a camera to be guided using a mounting system, whereby friction that can be adjusted by braking elements is generated and combined with an adjustable geometry of the bands in order to achieve individually adjustable vibration damping as well as individually adjustable load-bearing behavior over the lift of the parallelogram, with which camera guidance can be optimized. In order to either guide the camera in a smooth, damped movement as required or, if possible, to even prevent the camera from tracking, adjustable vibration damping is of enormous importance. If the friction of the braking elements is set to a minimum and there is a sudden change in position during filming to which the mounting system has to adapt, there is enough leeway for the mounting system to simply follow. Since the friction in the system is initially set to a minimum, the mounting system behaves underdamped. This leads to an overshoot of the new equilibrium position of the system and to a swing to the new equilibrium position of the system.

An overdamped mounting system represents a limiting case of the damping modality that can be adjusted via the braking elements, in which the impulse of the height change is completely damped. Here, the braking elements are adjusted so that the camera remains in its old equilibrium position when the height of the carrier changes, i.e., the vibrations are damped so much that the camera does not even swing into a new equilibrium position. As long as the carrier's height changes are within the system's range of motion, the camera remains in its old equilibrium position until the carrier manually positions the camera to a new equilibrium position.

Another property of the overdamped mounting system is that due to the existing high friction, any position within its range of motion functions as an equilibrium position. The carrier only has to position the camera once in the desired equilibrium position and it will remain there. Outside the overdamped mounting system, the system always has exactly one equilibrium position, which results from the balance of the lifting force of the arm and the gravitational force of the object to be carried.

Between the two extremes, the braking elements can also be tightened in such a way that the mounting system in question behaves as a critically damped mounting system. Here, too, the impulse of the permanent change in height is carried over, but here the camera will slowly rise from an old equilibrium position to a new equilibrium position. In this set damping modality, the movement is delayed in such a way that the new equilibrium position is established, but no swinging can occur, making the camera more stable.

The braking elements of the present invention realize all possible designs of vibration damping, including the damping modalities in between, in a single, cost-effective and individually adaptable mounting system.

In a first concrete embodiment, it may be provided that the braking elements are annular wedge discs with an inwardly wedge-shaped cross section, which are interposed between the guide rollers and a terminal bolt head formed on the fastening bolt. This results in optimal control of the friction between the cross member and the guide roller, allowing the damping to be changed by simply switching between the damping modalities described above, without having to resort to a new system.

Advantageously, the guide rollers may be associated with a plain bearing, preferably in the form of a polytetrafluoroethylene coating, and/or a needle bearing and/or a ball bearing and/or a rolling bearing. Due to these features, the friction between the guide rollers and the fastening bolts or the guide rollers and the elastic bands rubbing against them can be minimized as much as possible in the case of underdamped vibration. In this case, minimal friction is necessary to provide the mounting system with the lowest possible damping force.

Furthermore, it appears advantageous if the cross members and/or the guide rollers are made of aluminum or acrylonitrile butadiene styrene (ABS) plastic material. This creates a lightweight, stable and durable construction that can be manufactured cost-effectively and, with regard to the guide rollers, whose friction coefficient varies depending on the material chosen.

In a further embodiment, at least one guide roller may be mounted immovably. This eliminates unnecessary degrees of freedom in the mounting system, allowing users to switch between the individual damping modalities more quickly or to adjust their individual camera guidance more easily, as each guide roller does not have to be adjusted individually. However, it is still possible to realize mounting systems in which each guide roller can be individually adjusted. This gives the user the possibility to make a variety of adjustments to the holding arm themselves.

Preferably, several holding arms may be connected to one another via their end pieces. This creates additional flexibility and provides a greater number of combination options, allowing a variety of intermediate stages of the above-mentioned damping modalities to be realized without the need for a completely new system. However, several holding arms fastened to each other must be coordinated separately.

In a preferred embodiment, a knee joint protruding from the cross member may be attached to two anchor points, wherein the knee joint comprises a first joint foot and a second joint foot connected to the first joint foot via an articulated hinge, wherein the knee joint is associated with a guide roller to which at least one elastic band is attached. This allows the damping modalities to be individually adjusted, since such a knee joint can cause a greater stretch of the elastic band, which in turn affects the suspension properties. If a camera fastened on the mounting system is equipped with a different lens or a different camera is used, the mass that the mounting system has to dampen changes. If the mass is only slightly higher than a previous setting, but not so high that a second elastic band would be required, the use of such a knee joint is extremely advantageous. The knee joint can form a variable angle by being attached to different anchor points on the cross members, which allows the tensile stress of the elastic band attached to the guide rollers to be varied in stages. The band can also be attached to the guide rollers in different configurations to further vary the tensile stress. This allows the mounting system to be individually adapted to a wide variety of situations.

Preferably, the guide roller may be rotatably mounted on a fastening bolt at the at least one anchor point of the knee joint. Here, too, the friction can be individually controlled by means of a braking element in order to switch between the individual damping modalities without having to remove elements.

Furthermore, it appears advantageous if the at least one anchor point is attached to the articulated hinge. As a result, when the cross members are twisted towards the end pieces, the position of the guide roller changes more slowly than the position of other guide rollers on the cross members and the angles enclosed by the elastic bands used adapt as a result of these movements. Furthermore, the stretch of the elastic band changes via the lift of the arm. The knee joint presses harder into the band at the top dead center and moves out of the way at the bottom dead center. This counteracts the low tension at the top dead center and the high tension at the bottom dead center that occurs with diagonal tensioning. This results in a variable damping behavior, which results from the combination of the adaptability of the stretch curve of the bands via the lift of the arm and the adjustable friction.

In a specific embodiment, it may be provided that at least one of the end pieces of the holding arm is associated with an anchor point for attaching the first or second joint foot of the articulated hinge. This allows for more possible uses of the knee joint, as the additional anchor point results in a greater variation of angles that the knee joint can form with the cross members. Analogous to the possibility described above, such a modification results in even more customizable steps.

In a further embodiment, it appears sensible if the fastening bolts on a front side of the holding arm cooperate with further fastening bolts attached to a rear side of the holding arm. This allows elastic bands to be attached to both sides of the holding arm, the friction of which can be varied but always remains the same on both sides.

Advantageously, the fastening bolts may form a detachable connection with additional holding means at an anchor point of the holding arm. This allows the guide rollers to be removed and replaced as required or attached to other parts of the holding arm to optimally adapt to the respective environment.

Preferably, the fastening bolts can cooperate with a thread of a blind bore, wherein the fastening bolts may be glued in the blind bore. In the event that some guide rollers are to be mounted in a non-detachable manner, this type of fastening modality represents a cost-effective and effective solution. Such fastening can be achieved by means of an adhesive, in particular a special thread-locking adhesive, or a similar agent introduced into the screw threads.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 is a perspective view of the mounting system in which two holding arms are connected to each other with a total of four guide rollers per holding arm;

FIG. 2 and 3 show a perspective view of the mounting system with a total of eight guide rollers for two tensioning variations;

FIG. 4 and 5 show a perspective view of the mounting system with a total of six guide rollers and a heightening element for two tensioning variations;

FIG. 6 is a perspective view of the mounting system with a holding arm with a total of six guide rollers, one guide roller being attached to a knee joint;

FIG. 7 is a schematic view of a guide roller in an oblique view in the fastened state without the mounting system; and

FIG. 8 is a schematic exploded view of the guide roller in an oblique view with the fastening elements and braking means.

### DETAILED DESCRIPTION OF PREFERRED EMBODIMENTS

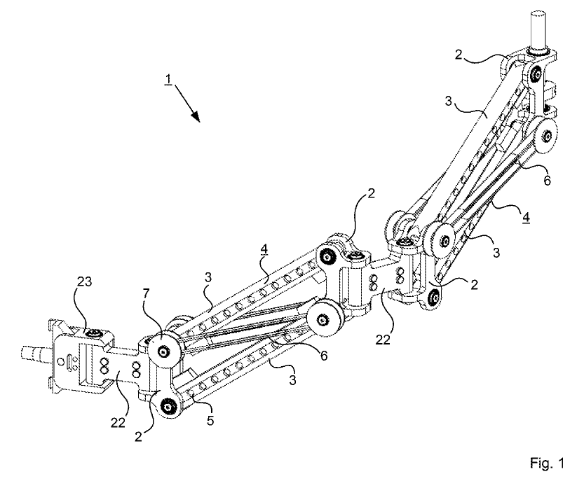

FIG. 1 shows schematically a mounting system in which two holding arms 1, each with two end pieces 2, are provided. The holding arms 1 are connected to each other via their end pieces 2. A connecting element 22 is provided between the two holding arms 1 of the mounting system, which also connects a support connector 23, which can be connected to a user’s support vest (not shown here), to one of the holding arms 1. The connecting elements 22 are screwed in such a way that the holding arms 1 can pivot at this point and allow a user maximum freedom of movement. Both holding arms 1 each have four guide rollers 7, with two guide rollers 7 being attached on a front side 16 and two guide rollers 7 being attached on a rear side 17 of the holding arm 1. The guide rollers 7 are attached diagonally opposite each other on the end pieces 2 of the holding arm 1. However, they may also be attached to any anchor points 5 of the cross members 3, so that elastic bands 6 stretched over the guide rollers 7 exert a lower spring force. Such an elastic band 6 is stretched over each of the guide rollers 7, so that a parallelogram 4 composed of two cross members 3 and two end pieces 2 can counter-spring when a weight is attached. The end pieces 2 may also be shaped differently so that a pin can be inserted on which a camera is fastened. An additional stopping point is provided here. Two holding arms attached one behind the other allow the user additional degrees of freedom in camera guidance and at the same time enable simple panning movements in a horizontal plane.

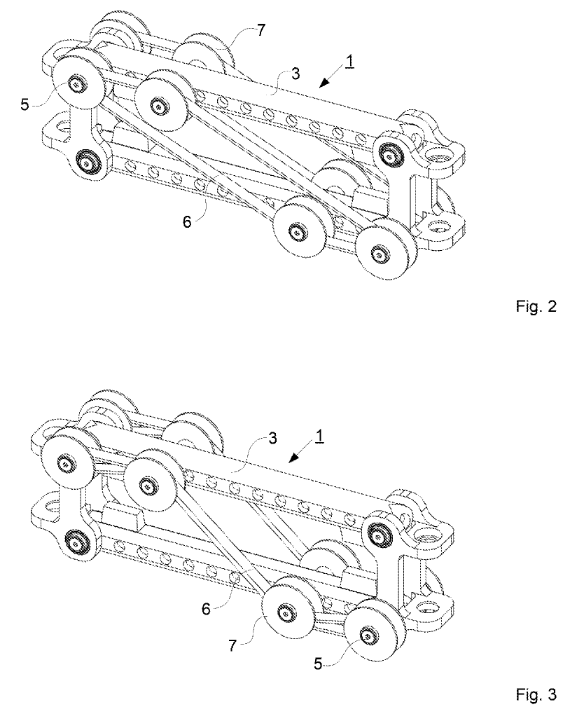

FIGS. 2 and 3 show schematic representations of the mounting system in an oblique view with a total of eight guide rollers 7, all of which are mounted on anchor points 5 located on the cross members 3 of the holding arm 1. FIG. 2 shows that the elastic band 6 passes through each guide roller 7 only once, whereas in FIG. 3 the elastic band 6 is attached such that the elastic band 6 is guided twice through the middle guide rollers 7 on the outward and return paths. This allows for increased tensile stress to be achieved through variable attachment in order to further optimize the damping properties of the mounting system.

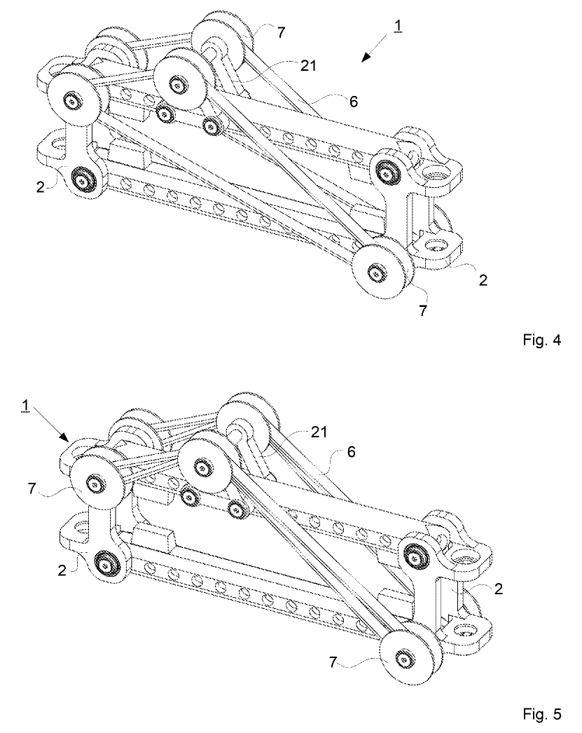

FIGS. 4 and 5 show schematic representations of the mounting system with a total of six guide rollers 7 and an elevating element 21 in an oblique view for two possible embodiments in which the elastic band 6 can be stretched over the holding arm 1. In FIG. 4, the elastic band 6 is tensioned around the guide rollers 7 attached to the end pieces 2 and passes through the guide roller 7 attached to the elevating element 21 once. FIG. 5 shows an embodiment in which the elastic band 6 passes through the guide roller 7 on the elevating element 21 twice, thereby bridging a greater distance and thus causing a greater stretching of the elastic band 6. Such an attachment slightly changes the damping properties of the system. In addition, the elastic band 6 is more dependent on the guide roller 7 of the elevating element 21 and its position along the cross members 3. Both end pieces 2 of the holding arm 1 are constructed identically in this embodiment.

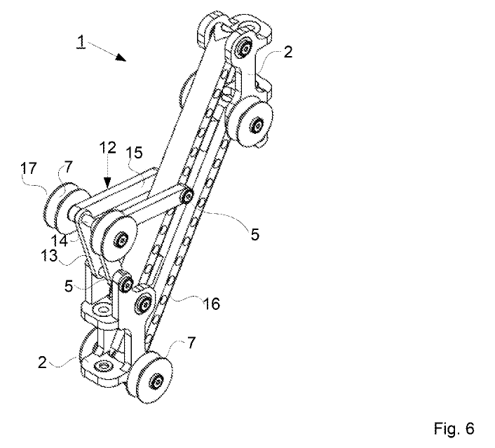

FIG. 6 shows a schematic representation of the mounting system with a total of six guide rollers 7 in an oblique view, wherein two guide rollers 7 are attached to a knee joint 12 which is located outside the holding arm 1. An end piece 2 is slightly modified and has an anchor point 5 at an elevated point, to which a first joint foot 13 of the knee joint 12 is mounted. A second joint foot 15 of the knee joint 12 is mounted centrally at an anchor point 5 of the cross member 3, but can be fastened to any other anchor point 5 along the cross member 3. The first joint foot 13 and the second joint foot 15 are designed so that they are approximately the same length. However, they can also be of different lengths and be straight or curved. The knee joint 12 has an articulated hinge 14 between the first joint foot 13 and the second joint foot 15, through the center of which an anchor point 5 located outside the cross members 3 runs. In this embodiment, the knee joint 12 has a single such external anchor point 5 for fastening a guide roller 7, but the knee joint 12 may also be designed such that it has several such anchor points 5. At the anchor point 5 of the knee joint 12 shown here, a guide roller 7 is attached to a front side 16 and a rear side 17 of the knee joint 12. The holding arm 1 shown here is shown without the elastic bands 6 for illustrative purposes. Such a knee joint 12 can be mounted at different anchor points 5 of the holding arm 1 and thus forms different angles, whereby the path of an elastic band 6, not shown here, stretched around the three guide rollers 7 becomes variable and thus the spring force of the holding arm 1 can be adjusted. At the same time, the angle of the knee joint 12 changes during an inclination of the parallelogram 4, in which the angle between the end pieces 2 and the cross members 3 changes.

The views in FIGS. 2 and 3 could also be extended as desired with such a knee joint 12 or with an elevating element 21, as shown in FIGS. 4 and 5. Also, several elastic bands 6 could overall be attached around the guide rollers 7, then - as shown in the FIGS. - one elastic band 6 per side. In addition, in the views all anchor points 5 of the cross members 3 are shown identically and equidistantly. However, they can also be associated with different bearings to ensure increased variation in friction, between which a user can vary as desired. The anchor points 5 may also be provided at different distances from each other.

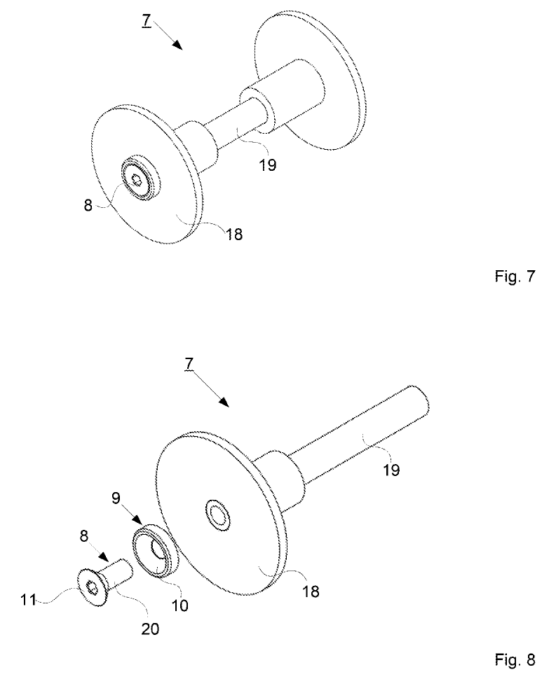

FIG. 7 shows a schematic representation of a guide roller 7 in the fastened state, but without the mounting system, in an oblique view. In this embodiment, the guide roller 7 is a one-piece, round-shaped fastening disc 18, which is attached to a brake element 9 by fastening bolts 8 on an axle 19 from both sides and can be firmly attached thereon. Two such fastening discs 18 attached to the same axle 19 form a guide roller 7 which can be attached to the anchor points 5 of the holding arm 1. The guide roller 7 thus represents a simple, functional and cost-effective element that can be manufactured using simple means and is easy to disassemble.

FIG. 8 shows a schematic representation of a part of the guide roller 7 in an oblique view as an exploded view. In this view, the fastening bolt 8 with the bolt head 11 is a screw 20 which cooperates with an internal thread of the axle 19 and fastens the guide roller 7. A braking element 9 in the form of a wedge disk 10 is arranged between the screw 20 and the guide roller 7. The friction can be controlled and varied by the torque applied to the screw 20. A variation in friction causes a controllable change in the position of the elastic bands attached to the guide rollers while being stretched. This allows the damping modalities of the mounting system to be influenced. Anchor points 5 that have no play and are thus connected to the rest of the holding arm 1 by static friction can also be used.

What is described above is a cost-effective mounting system that enables adjustable decoupling of an object from the carrier as well as adjustable damping behavior of occurring vibrations.

Although only a few embodiments of the present invention have been shown and described, it is to be understood that many changes and modifications may be made thereunto without departing from the spirit and scope of the invention.

### LIST OF REFERENCE SIGNS

1 holding arm

2 end piece

3 cross member

4 parallelogram

5 anchor point

6 elastic band

7 guide roller

8 fastening bolts

9 braking element

10 wedge disc

11 bolt head

12 knee joint

13 first joint foot

14 articulated hinge

15 second joint foot

16 front side

17 rear side

18 fastening disc

19 axle

20 screw

21 elevating element

22 connecting element

23 support connectors

What is claimed is:

1. A mounting system for a camera for position stabilization and for damping vibrations, comprising a holding arm (1) with two end pieces (2) and two cross members (3), wherein the cross members (3) are articulated to the end pieces (2) to form a parallelogram (4) and each cross member (3) is associated with a plurality of anchor points (5) for attaching at least one elastic band (6),
wherein the holding arm (1) has at least two anchor points (5) at which guide rollers (7) are arranged, to which at least one elastic band (6) is attached, wherein the guide rollers (7) are rotatably attached on fastening bolts (8) on the holding arm (1) and adjustable braking elements (9) are associated with the fastening bolts (8).

2. The mounting system in accordance with claim 1, wherein the braking elements (9) are annular wedge discs (10) with an inwardly wedge-shaped cross section, which are interposed between the guide rollers (7) and a terminal bolt head (11) formed on the fastening bolt (8).

3. The mounting system in accordance with claim 1, wherein a plain bearing, preferably in the form of a polytetrafluoroethylene coating, and/or a needle bearing and/or a ball bearing and/or a rolling bearing is associated with the anchor points (5).

4. The mounting system in accordance with claim 1, wherein the cross members (3) and/or the guide rollers (7) are made of aluminum or acrylonitrile butadiene styrene (ABS) plastic material.

5. The mounting system in accordance with claim 1, wherein at least one guide roller (7) is mounted immovably.

6. The mounting system in accordance with claim 1, wherein several holding arms (1) are connected to one another via their end pieces (2).

7. The mounting system in accordance with claim 1, wherein a knee joint (12) projecting from the cross member (3) is attached to two anchor points (5), wherein the knee joint (12) comprises a first joint foot (13) and a second joint foot (15) connected to the first joint foot (13) via an articulated hinge (14), wherein the knee joint (12) is associated with a guide roller (7) to which at least one elastic band (6) is attached.

8. The mounting system in accordance with claim 7, wherein the guide roller (7) is rotatably mounted on a fastening bolt (8) at the at least one anchor point (5) of the knee joint.

9. The mounting system in accordance with claim 7, wherein the at least one anchor point (5) is attached to the articulated hinge (14).

10. The mounting system in accordance with claim 7, wherein at least one of the end pieces (2) of the holding arm (1) is associated with an anchor point (5) for attaching the first or second joint foot (13), (15) of the articulated hinge (14).

11. The mounting system in accordance with claim 1, wherein the fastening bolts (8) from a front side (16) of the holding arm (1) cooperate with further fastening bolts (8) attached to a rear side (17) of the holding arm (1).

12. The mounting system in accordance with claim 1, wherein the fastening bolts (8) form a detachable connection with further holding means at an anchor point (5) of the holding arm (1).

13. The mounting system in accordance with claim 1, wherein the fastening bolts (8) cooperate with a thread of a blind bore, wherein the fastening bolts (8) are glued in the blind bore.
